(19) United States
(12) Patent Application Publication
(10) Pub. No.: US 2026/0298607 A1
(43) Pub. Date: Oct. 1, 2026

(54) BREAK BEAM CALIPER

(71) Applicant: William R. VILLANI, Lancaster, PA (US)

(72) Inventor: William R. VILLANI, Lancaster, PA (US)

(21) Appl. No.: 19/548,427

(22) Filed: Feb. 24, 2026

Related U.S. Application Data
(60) Provisional application No. 63/780,008, filed on Mar. 28, 2025.

(51) Int. Cl. G01B 3/20; G01V 8/12

(52) U.S. Cl. CPC G01B 3/20; G01V 8/12

(57) ABSTRACT

A digital caliper and a method of use is disclosed. The digital caliper is useful for measuring softer and easily deformed items. The digital caliper includes a fixed jaw and a movable jaw including a mounted break beam system. When the jaws close around a measurement target, a signal is generated when the measurement target interrupts the beam, prompting the reversal of the movable jaw. Measurement is automatically taken when the beam is again uninterrupted.

### FIELD OF THE INVENTION

The present disclosure is generally directed to devices for measuring objects and their methods of use. More particularly, the subject matter of this application pertains to devices for measuring easily deformed objects and their methods of use. Even more particularly, the subject matter of this application pertains to calipers utilizing a light beam to measure objects.

### BACKGROUND OF THE INVENTION

The subject matter of this application is an apparatus for measuring soft materials, particularly those that are deformable or pliable in nature. This class of materials encompasses a wide range of substances with varying properties and characteristics, including fabrics, plastics, and biological tissues. Instruments such as a caliper record the distance between two points and typically utilize two opposing structures that close around the object being measured. When measuring non-pliable structures, these opposing structures (or “jaws”) press against the target, and the caliper registers the distance between the jaws. Softer, pliable materials are more challenging to measure accurately as they may deform when pressed between the jaws. Current methods to measure soft materials are centered around having a light touch.

Accordingly, there remains a need for calipers that can accurately measure soft materials without causing those materials to deform.

### SUMMARY OF THE INVENTION

The subject matter of this application addresses these needs.

In one aspect, the present disclosure relates to an apparatus for measuring soft, deformable materials, which comprises a static jaw; and a movable jaw comprising two projections at its top and bottom ends projecting towards the static jaw, wherein the paired projections comprise a break beam system with one projection emitting a light beam and the other end detecting interruptions of said light beams.

In most useful embodiments, the apparatus further includes an embedded microchip for registering measurements when triggered.

In some embodiments, the static jaw comprises a stabilizing projection configured to be adjusted independently to support the item being measured.

This apparatus may include an anti-vibration mechanism integrated into its design to reduce external influences on the measuring process and is configured to take repeated measurements without compromising accuracy.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF DRAWINGS

FIG. 1 illustrates a caliper as described herein.

FIG. 2 is another view of the caliper with the jaws apart.

FIG. 3 is another view of the caliper with the jaws in a zero position.

FIG. 4 is an illustration of the movable jaw and associated slidable body.

FIG. 5a is a section of FIG. 4 showing some internal details.

FIG. 5b is a perspective view of a light beam emitter module

FIG. 6 illustrates an alternative to the measuring stage, which is adapted to measure the wall thickness of tubing.

FIG. 7 is a flowchart illustrating a method of setting a zero point with the disclosed subject matter.

FIG. 8 is a flowchart illustrating a method of taking a measurement with the disclosed subject matter.

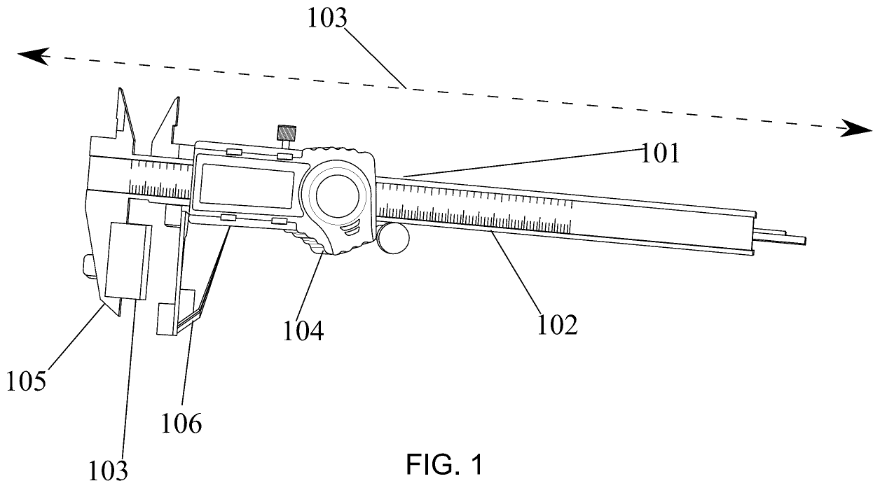

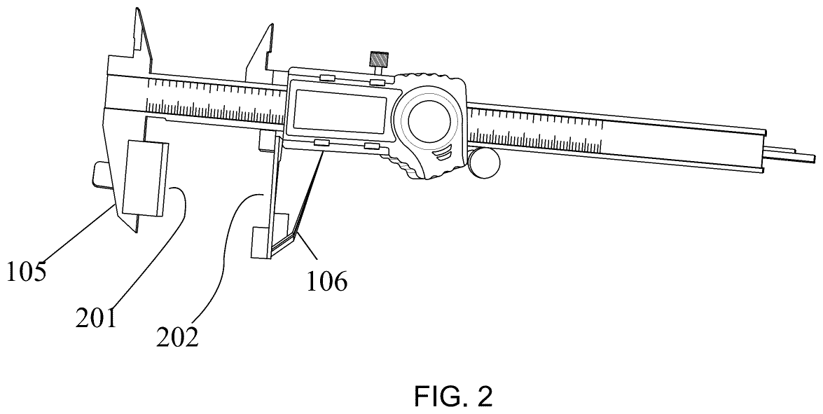

### DETAILED DESCRIPTION OF THE INVENTION

While the exemplary embodiments illustrated in the figures and described herein are presently preferred, these embodiments are only examples. Accordingly, the present application is not limited to a particular embodiment but extends to various modifications that fall within the scope of the appended claims. The order or sequence of any processes or method steps may be varied or resequenced in alternative embodiments.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the positions of elements may be reversed or otherwise varied, and the nature or number of discrete elements or positions may be altered. Accordingly, all such modifications are intended to be included within the scope of the present application. The order or sequence of any process or method steps may be varied or resequenced in alternative embodiments. In the claims, any means-plus-function clause is intended to cover the structures described herein as performing the recited function and not only structural equivalents but also equivalent structures. Other substitutions, modifications, changes, and omissions may be made in the design, operating conditions, and arrangement of the exemplary embodiments without departing from the scope of the present application.

Uses of the verbs ‘include’ and ‘have’ should be understood to mean ‘comprise,’ i.e., the terms are inclusive and open-ended and do not exclude additional elements or steps.

The term “caliper” should be understood to encompass calipers, micrometers, as well as any device operating in the same or similar manner. A “target” or “measuring target” is the object being measured. The measurements taken by a caliper are of spatial distance.

Reference numbers are given as three digits. The first digit refers to the illustration in which the referenced item is first or best shown.

The digital caliper (101) includes a main scale (102) defining a longitudinal axis (103) and a primary body (104) slidably coupled to the main scale. A static jaw (105) is fixed relative to the main scale and extends perpendicularly to the longitudinal axis. A movable jaw (106) is coupled to the primary body.

Both the static jaw (105) and the movable jaw (106) include internal facing surfaces (202 and 203, respectively) configured to engage a measuring target.

The movable jaw comprises an axis (401) perpendicular to the longitudinal axis (103) of the main scale. It includes a top projection (402) and a bottom projection (403), each extending from the internal facing surface (202) of the movable jaw and oriented parallel to the longitudinal axis (103) of the main scale. The top projection is positioned proximally to the main scale (102), while the bottom projection (403) is positioned distally to the main scale.

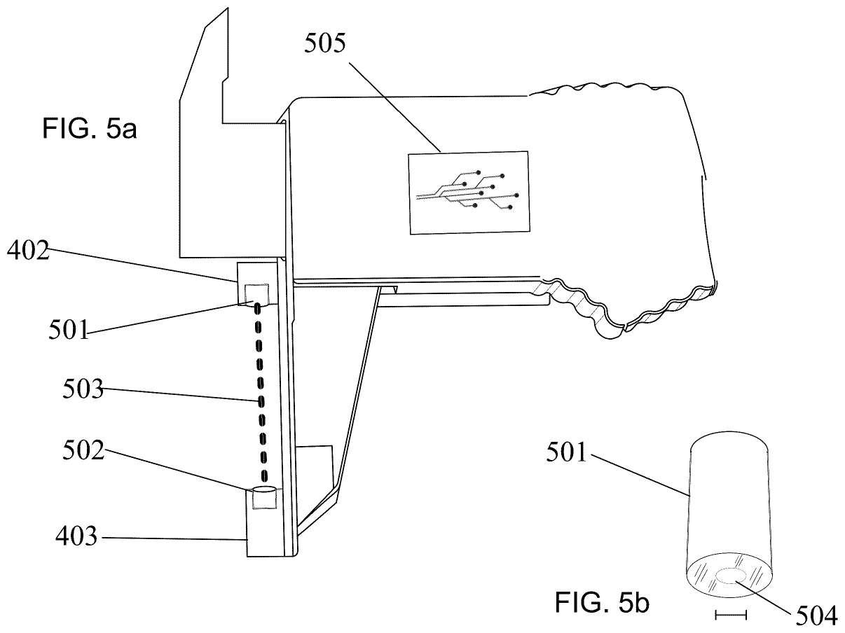

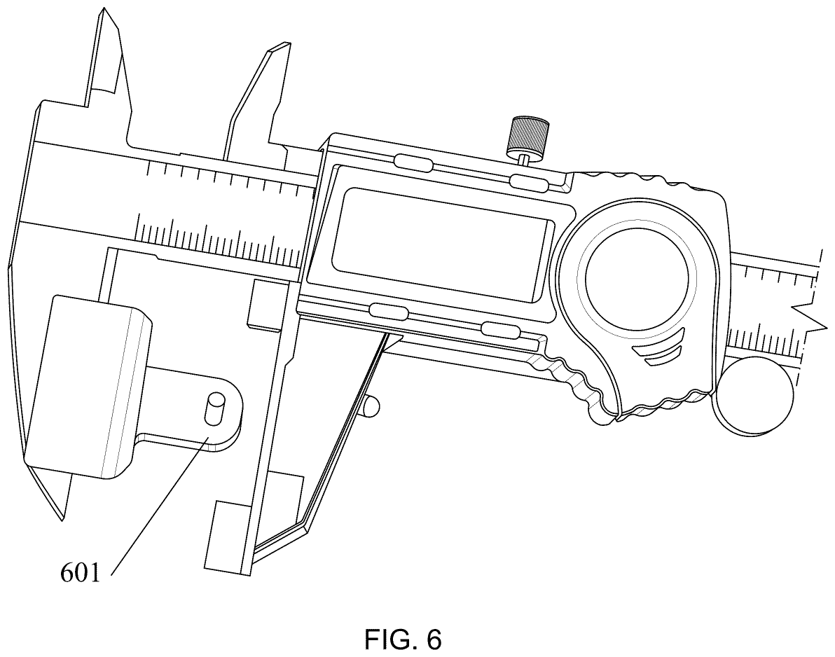

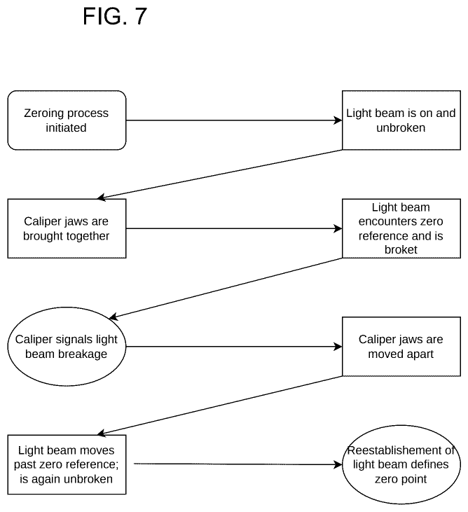

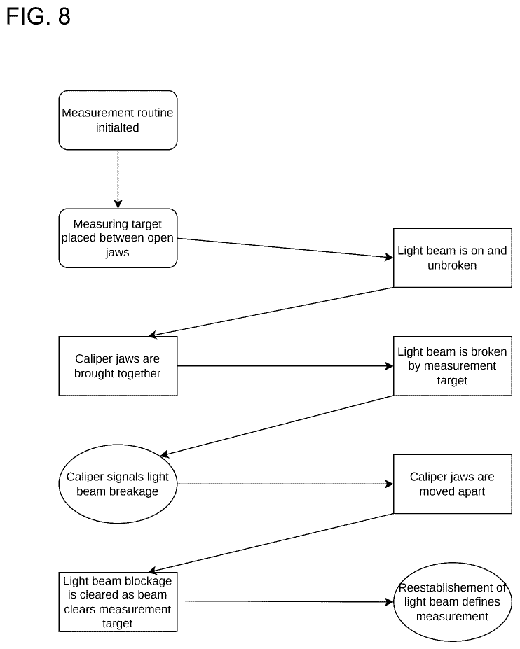

The top projection comprises a first component (501) of a break-beam system, and the bottom projection comprises a second component (502) of the break-beam system. In one embodiment, the break-beam system comprises a light beam emitter module (e.g., 501) and a light beam sensor module (e.g., 502), aligned such that a beam of light (503) emitted by the emitter module extends perpendicular to the longitudinal axis of the main scale and is detectable by the sensor module when not interrupted (see FIG. 5). The beam of light (503) is stylized as a thick, dashed line in the figures to aid understanding of the subject matter, not to portray the beam realistically.

The fixed jaw comprises an axis perpendicular to the longitudinal axis (103) of the main scale and parallel to the axis of the movable jaw (401), and a measurement stage (103)

In certain embodiments, the light beam emitter module (501) is adapted to emit infrared light having a wavelength of approximately 850 nm and may include a beam-limiting orifice (504), such as a 0.007-inch (0.177 mm) radius orifice, to define a narrow, well-controlled beam profile.

Note that although the light beam emitter module may be marked as reference number 501, which is shown to be near the primary body and the light beam sensor module may be marked as reference number 502, which is shown to be further from the primary body, the placement of the components of the break-beam system may be reversed, i.e., the emitter may be located at the bottom projection of the mobile jaw and the sensor may be located at the top projection of the mobile jaw.

Additionally, although the break beam system is described as being located at the movable jaw and the measurement stage located at the static jaw, the locations of the break beam system and the measurement stage may be reversed.

In most highly preferred embodiments, the digital calipers includes a printed circuit board (PCB) (505) disposed within the primary body (104) of the digital caliper. One or more processors are operatively coupled to the PCB and configured to execute instructions stored thereon.

In certain favored embodiments, the measurement stage is removable and replaceable with other specialized measurement stages. Examples of specialized measurement stages include those with a divot or similar feature that better abut a measurement target, those adapted to interface with a measurement target via attachment means such as a pin or clip, and those adapted to hold tubing (601) and allow measurement of wall thickness.

The processors are configured to calculate a position of the movable jaw relative to the static jaw based on scale encoding, sensor signals, or other position-determining mechanisms; detect interruption of the beam of light and generate a first signal indicating that a measuring target is present between the jaws; continuously track the position of the movable jaw as the jaws are moved in an opening direction; and detect re-establishment of the beam of light and record a dimensional measurement corresponding to the position of the movable jaw at the time the beam becomes unbroken.

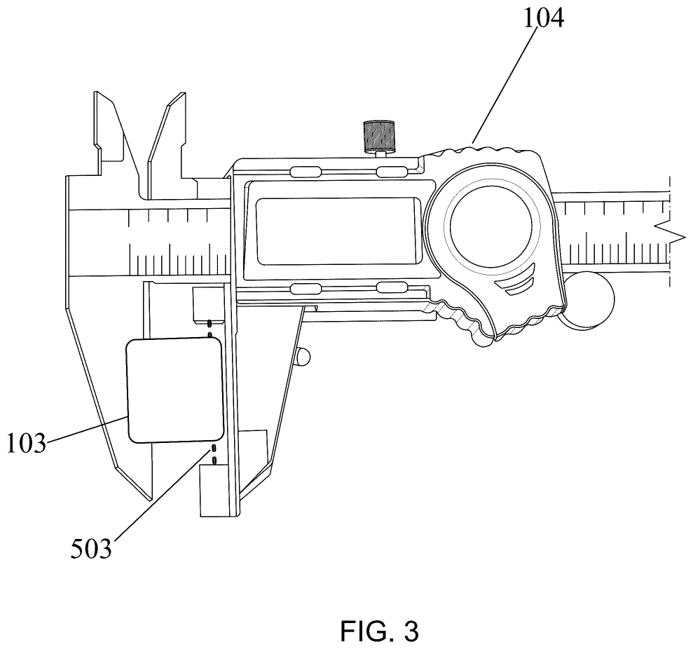

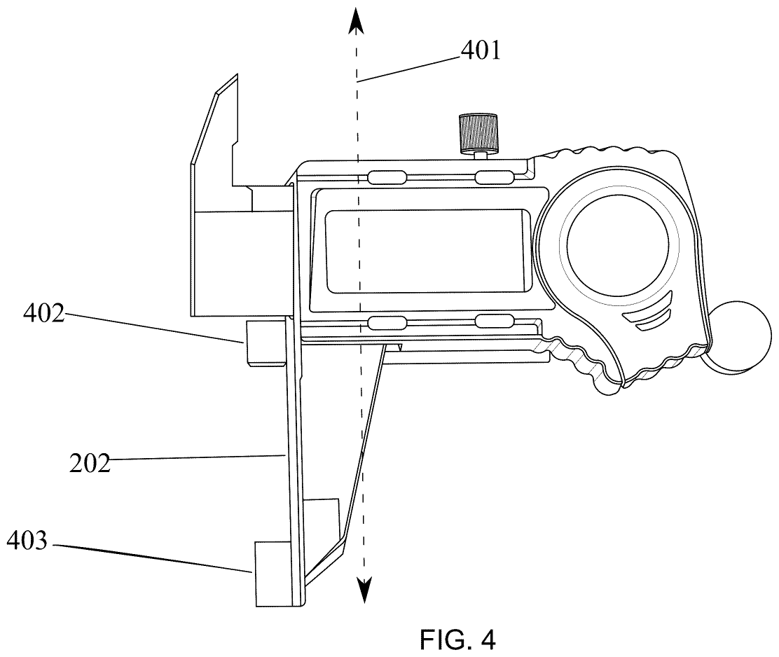

Most preferably, before measuring a target object, the caliper is “zeroed.” Such a zero point can and should be set as often as needed. The zeroing activity is triggered by a button press or similar interaction with the primary body that readies zeroing. Once the zeroing activity is triggered the light beam is activated, signals an intact beam, and the jaws are brought together at least until the measurement stage of the fixed jaw interrupt or “breaks” the light beam (503) of the movable jaw (see FIG. 3). At that point, a signal is generated by the caliper, and the jaws are separated until the continuity of the light beam is reestablished. The digital caliper then records the position of the movable jaw as the “zero” position.

The measurement activity is essentially the same as the above-described zeroing activity, except it includes a measuring target in contact with the measurement stage. Similarly, the measurement activity is triggered by a button press or similar interaction with the primary body. Initially, the light beam is activated and signals an intact beam, and the movable jaw moves or is moved toward the static jaw. As the jaws close, the measurement target extends into the space between the top and the bottom projections of the movable jaw and breaks the light beam. The breaking of the light beams signals the separation of the jaws until the re-establishment of the beam signals the processor within the primary body to record the position of the movable jaw.

Although the zeroing process is optional, most operators will periodically “zero” the caliper to calibrate the instrument.

In another embodiment, the measurement process can be controlled by a microcontroller and one or more motors that actuate the digital calipers, opening and closing the jaws. Such an embodiment would allow the apparatus to automatically zero and measure a target.

The disclosed system and method enable measurements to be taken via optical detection rather than solely through physical contact, improving repeatability and reducing user-induced error. Measuring as the jaws open and the light beam is reestablished, instead of measuring the position of the movable jaw when the light beam breaks, mitigates the effects of measuring target compression or jaw deflection commonly associated with manual caliper use.

1. A digital caliper, comprising:
a main scale having a longitudinal axis;
a primary body slidably coupled to the main scale;
a static jaw fixed relative to the main scale and having an internal facing surface configured to engage a measuring target;
a movable jaw orthogonal to the main scale, and coupled to the primary body and movable relative to the static jaw, the movable jaw having an internal facing surface facing the internal facing surface of the static jaw;
means for emitting a beam of light across a measurement region between the internal facing surfaces of the static jaw and the movable jaw;
means for detecting the beam of light; and
means for determining whether a measuring target is present between the static jaw and the movable jaw based on interruption of the beam of light,
wherein the beam of light extends in a direction perpendicular to the longitudinal axis of the main scale.

2. The digital caliper of claim 1 wherein said movable jaw comprises a top projection and a bottom projection,
said top projection being proximal to the main scale, and said bottom projection being distal to the main scale;
each said projection extending from the movable jaw and being parallel to the main scale;
the top projection comprising a first component of a break-beam system, and
The bottom projection comprising a second component of a break-beam system;
The first component of a break-beam system and the second component of a break-beam system being positioned such that a beam of light generated from one component is perpendicular to the main scale and is detectable by a sensor on the other component.

3. The digital caliper of claim 2 in which said break-beam system is comprised of an emitter component adapted to emit a light beam, and a detector component adapted to detect the light beam emitted by the emitter component.

4. The digital caliper of claim 3 in which the emitter component comprises a 0.0.007″ (0.177 mm) light-beam-radius limiting orifice.

5. A digital caliper, comprising:
a main scale having a longitudinal axis, a first end, and a second end;
a primary body slidably coupled to the main scale;
a static jaw projecting from the first end of the main scale in a direction perpendicular to the longitudinal axis;
the static jaw having an internal facing surface configured to contact a measuring target; and
a movable jaw projecting from the primary body and movable relative to the static jaw;
the movable jaw having an internal facing surface facing the internal facing surface of the static jaw;
wherein the movable jaw further comprises a top projection and a bottom projection, each extending from the internal facing surface of the movable jaw and oriented parallel to the longitudinal axis of the main scale;
wherein the top projection comprises a first component of a break-beam system and the bottom projection comprises a second component of the break-beam system;
wherein the break-beam system comprises a light beam emitter module and a light beam sensor module; and
wherein the first component and the second component are aligned such that a beam of light emitted by the light beam emitter module extends perpendicular to the longitudinal axis of the main scale and is detectable by the light beam sensor module when the beam is not interrupted.

6. The digital caliper of claim 5 in which the light beam emitter is adapted to emit a beam of light having a wavelength of 850 nm.

7. The digital caliper of claim 5, further comprising a printed circuit board disposed within the primary body; one or more processors operatively coupled to the printed circuit board; and
instructions stored on the printed circuit board which, when executed by the one or more processors, cause the digital caliper to
calculate a position of the movable jaw relative to the static jaw;
detect interruption of the light beam of the break-beam system and generate a first signal indicative of beam breakage;
while the jaws are moved in an opening direction, continuously track the calculated position of the movable jaw; and
upon re-establishment of the light beam after the interruption, generate a second signal and record a dimensional measurement corresponding to the calculated position of the movable jaw at the time the light beam becomes unbroken.

8. A method for using a digital caliper comprising a break-beam system, the method comprising the steps of:
providing a digital caliper having a main scale, a static jaw fixed relative to the main scale, a movable jaw movable relative to the static jaw, and a break-beam system configured to project a beam of light across a measurement region between internal facing surfaces of the static jaw and the movable jaw;
moving the movable jaw relative to the static jaw toward a measuring target;
emitting, with an emitter component of the break-beam system, a beam of light extending across the measurement region in a direction perpendicular to a longitudinal axis of the main scale;
detecting, with a detector component of the break-beam system, the beam of light when the beam is uninterrupted;
interrupting the beam of light with the measuring target positioned between the static jaw and the movable jaw;
in response to interruption of the beam of light, generating a first signal indicating the presence of the measuring target between the jaws;
opening the jaws by moving the movable jaw away from the static jaw while tracking a position of the movable jaw relative to the static jaw;
detecting re-establishment of the beam of light as the measuring target exits the measurement region; and
recording a dimensional measurement corresponding to the position of the movable jaw at the time the beam of light is re-established.
